(19) United States
(12) Patent Application Publication
(10) Pub. No.: US 2015/0102981 A1
(43) Pub. Date: Apr. 16, 2015

(54) EYE TRACKING

(71) Applicant: MICROSOFT CORPORATION, Redmond, WA (US)

(72) Inventors: Bongshin LEE, Issaquah, WA (US); Kenneth P. HINCKLEY, Redmond, WA (US); Steven N. BATHICHE, Kirkland, WA (US)

(73) Assignee: MICROSOFT CORPORATION, Redmond, WA (US)

(21) Appl. No.: 14/177,102

(22) Filed: Feb. 10, 2014

Related U.S. Application Data
(60) Provisional application No. 61/890,027, filed on Oct. 11, 2013.

(51) Int. Cl. G06F 3/01; G02B 27/01

(52) U.S. Cl. CPC G06F 3/013; G02B 27/017
USPC 345/8

(57) ABSTRACT

The description relates to eye tracking. One example can identify a location that a user is looking. The example can also identify content at the location.

### BACKGROUND

Various attempts have been made to assist users in utilizing computing resources. For instance, user search queries and selections of results can be stored to try to customize future searches. However, these attempts offer very little insight into the user beyond knowing what the user typed and clicked.

### SUMMARY

The description relates to eye tracking. One example includes sensors configured to identify a location that a user is looking. The example also includes a content correlation component configured to identify content at the location.

Another example can display digital content and determine that a user is looking at a sub-set of the digital content. This example can relate the user and the sub-set of the digital content. The example can cause the sub-set of the digital content to be added to a memory-mimicking user profile associated with the user. The memory-mimicking user profile can contain searchable data relating to what the user has previously viewed.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced.

FIG. 1 is a flowchart of an example visualization technique in accordance with some implementations of the present concepts.

FIGS. 2-8 show example visualization scenarios in accordance with some implementations of the present concepts.

FIGS. 9-15 show example visualization systems in accordance with some implementations of the present concepts.

FIGS. 16-17 are flowcharts of example visualization techniques in accordance with some implementations of the present concepts.

### OVERVIEW

The description relates to determining what a user(s) looks at via eye tracking. The information about what the user looks at can then be used to provide the user with an enhanced user experience and/or for other uses.

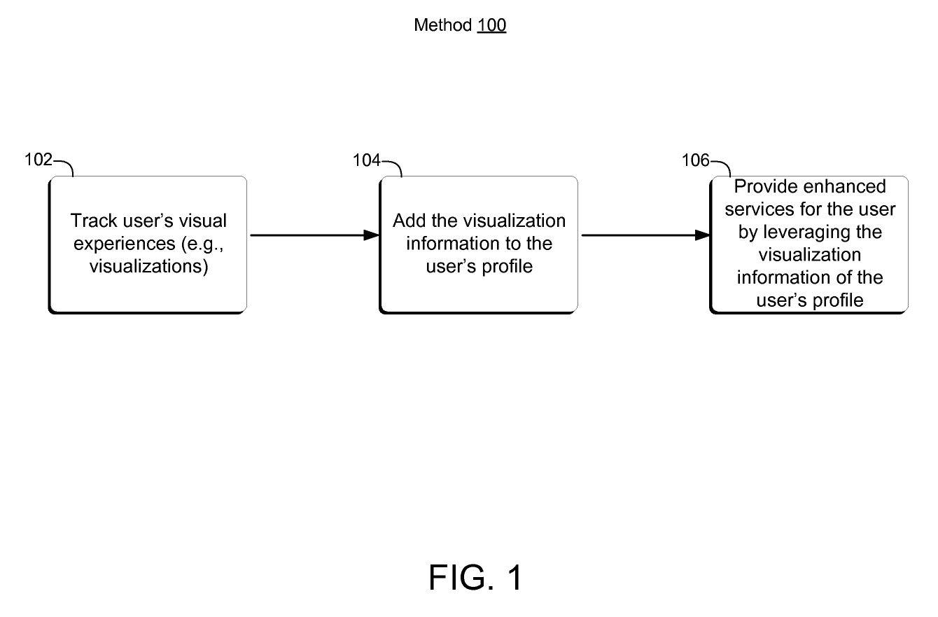

For introductory purposes consider FIG. 1 which shows a method 100. The method can track a user's visual experiences (e.g., visualizations) at 102. The visualizations and associated metadata can be termed ‘visualization information.’ The method is explained relative to a single user but can also be applied to multiple users. Some implementations can be directed to digital content (e.g., what digital content did the user look at). Digital content can be characters (such as text), images, and/or other forms of digital content. For instance, these implementations can determine what particular digital content on a display device the user is looking at when the user looks at the display device. For example, the implementations can determine that the user is looking at location “A” and at that time content “B” was displayed at location “A.”

Other implementations are not limited to digital content. These implementations can determine when the user is looking at physical content (e.g., non-digital content). Thus, viewing of both physical content and digital content can be tracked. This visualization information can be added to the user's profile at 104. Considered from one perspective, the visualization information can be used to create a “memory-mimicking user profile” or be added to an existing memory-mimicking user profile. Thus, as used in this document, “content” can be anything that is viewable by a user and “viewed content” is the sub-set of the content that the user looked at. The content and/or the viewed content can be treated as part of the visualization information.

The method can provide enhanced services for the user by leveraging the visualization information of the memory-mimicking user profile at 106. From one perspective, the visualization information can be used to enhance the user experience and/or future user experiences. For instance, the user may query “I remember reading about the Mars rover mission looking for water on Mars.” The visualization information of the memory-mimicking user profile can be searched to retrieve the corresponding content that the user viewed. Of course, this is only one way that the memory-mimicking user profile can be utilized to enhance user experiences, some of which are described below. Further, the visualization information can be used for other purposes beyond the memory-mimicking user profile.

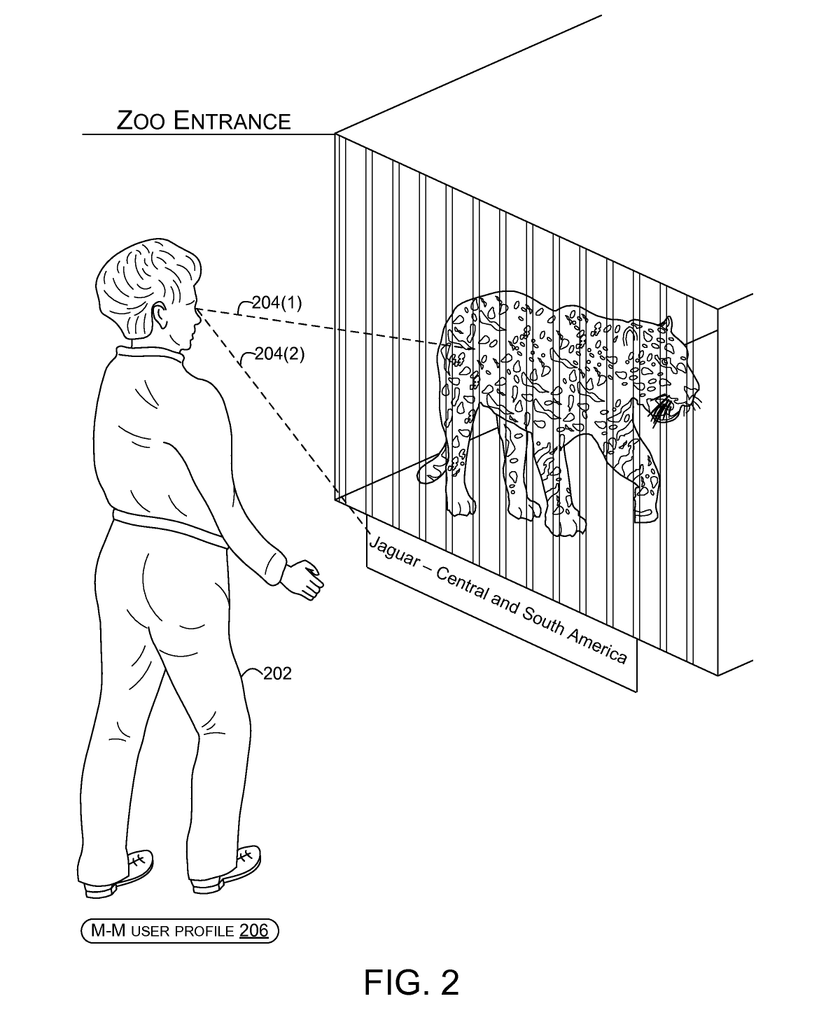

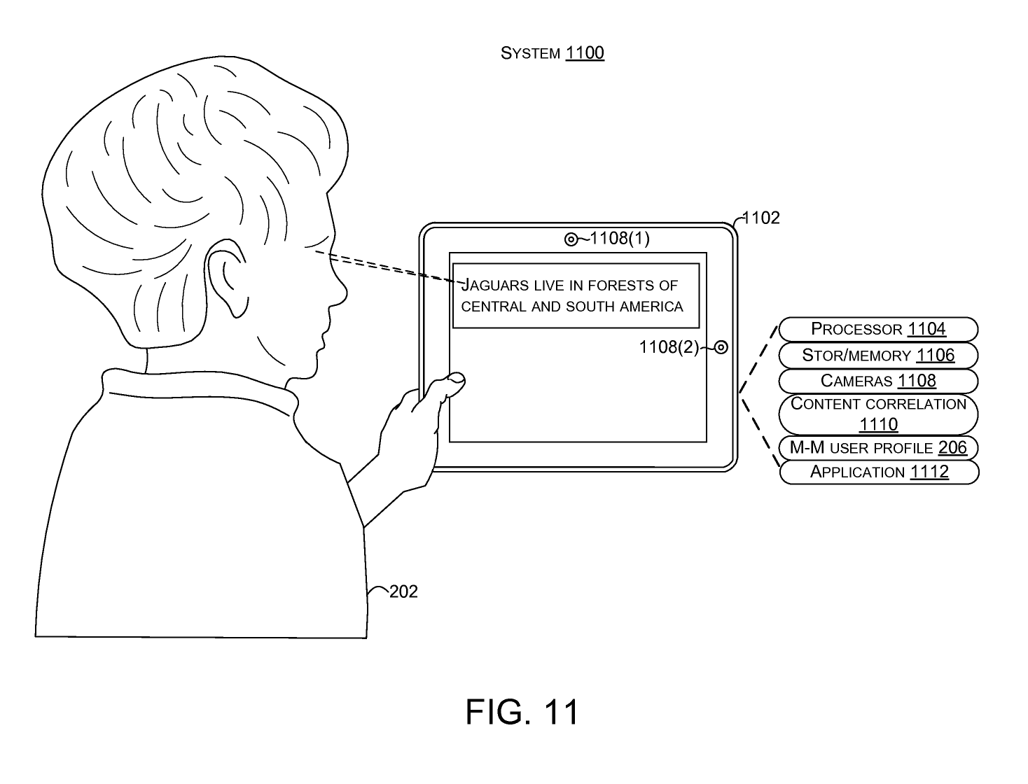

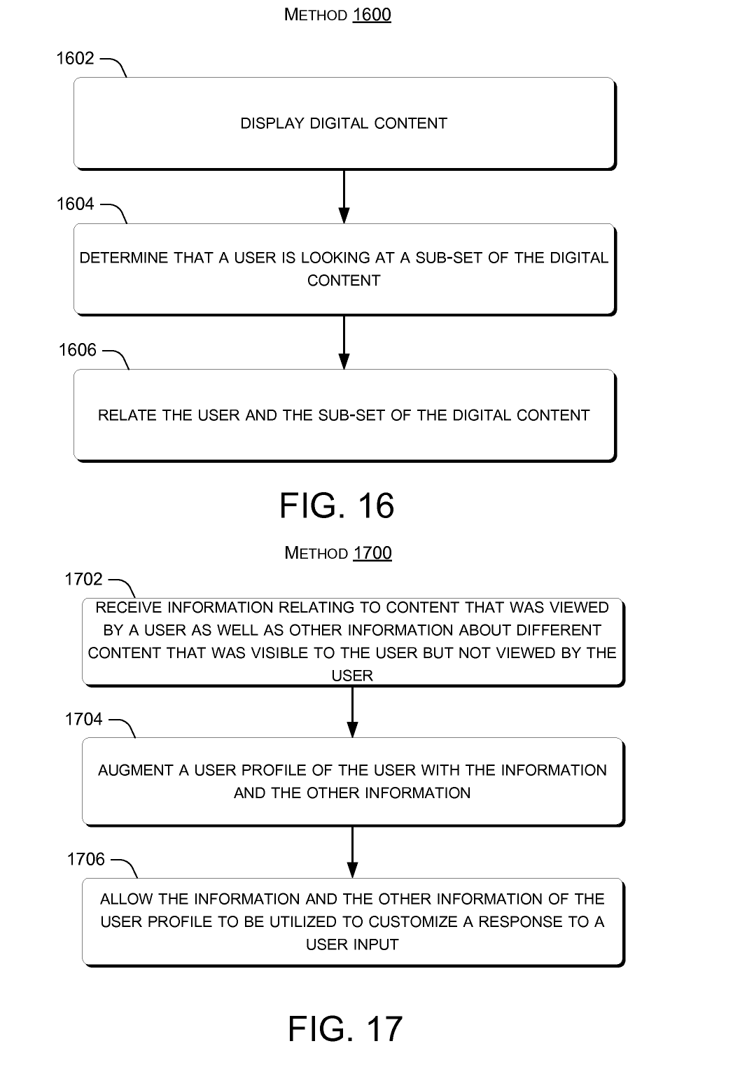

FIGS. 2-10 collectively illustrate scenarios in which the present visualization concepts can be applied. FIGS. 11-15 illustrate devices that can accomplish visualization concepts. FIGS. 16-17 are flow charts of visualization methods.

FIG. 2 shows a user 202 at a zoo. The user's eyes can be tracked at the zoo at 204. In this case, the user looked at a jaguar in an enclosure at 204(1) and then the user looked at an information plate that identifies the animal as a jaguar from Central and South America at 204(2). These visualizations (e.g., what the user looked at) can be associated with metadata, such as the location (e.g., zoo, which zoo in which city, etc.), date, time, and/or who the user was with, among others. This visualization information can be added to the user's memory-mimicking user profile 206, which is described in more detail below.

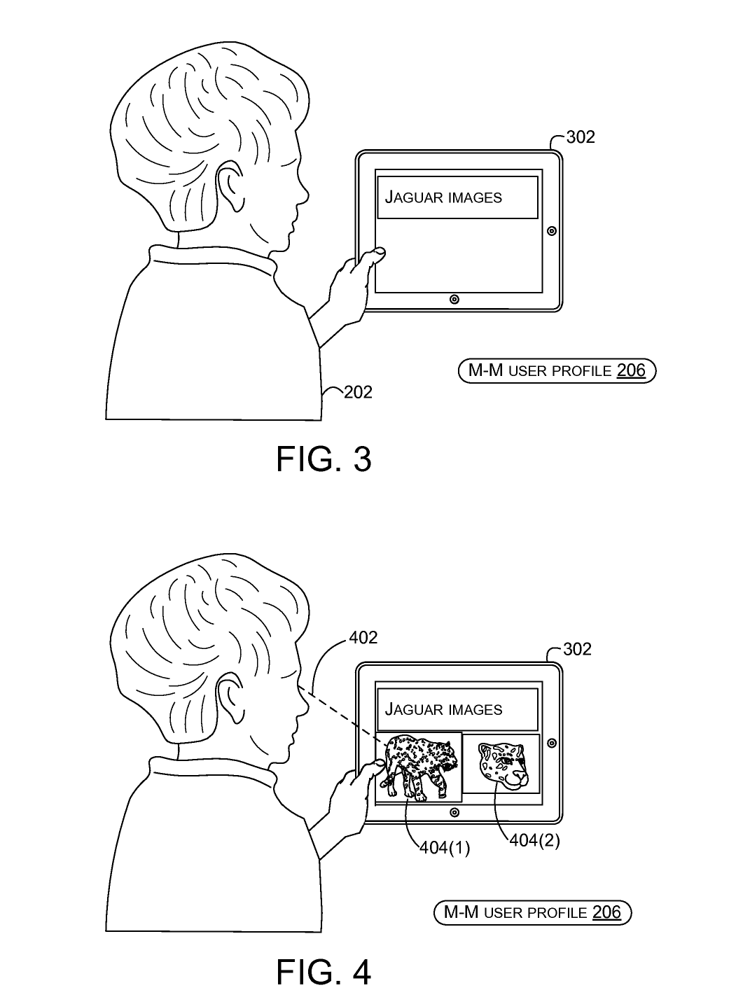

FIG. 3 shows an instance where the user 202 subsequently enters a search query for “jaguar images” on the user's computing device 302. In this case, the visualization information in the memory-mimicking user profile 206 can be used to determine (e.g., disambiguate) that the user likely wants to see images of the ‘jaguar animal’ rather than a ‘jaguar car’ or a ‘jaguar sports team,’ for instance. Stated another way, the visualization information that the user recently went to the zoo and looked at a jaguar can be utilized to customize the user's computing experience.

FIG. 4 shows the user's eyes being tracked at 402 when two jaguar images 404(1) and 404(2) are displayed for the user on device 302 responsive to the query of FIG. 3. In this example, the eye tracking 402 determined that the user briefly looked at both images and then dwelled on the left image 404(1) and ignored the right image 404(2). This visualization information can be added to the user's memory-mimicking user profile 206.

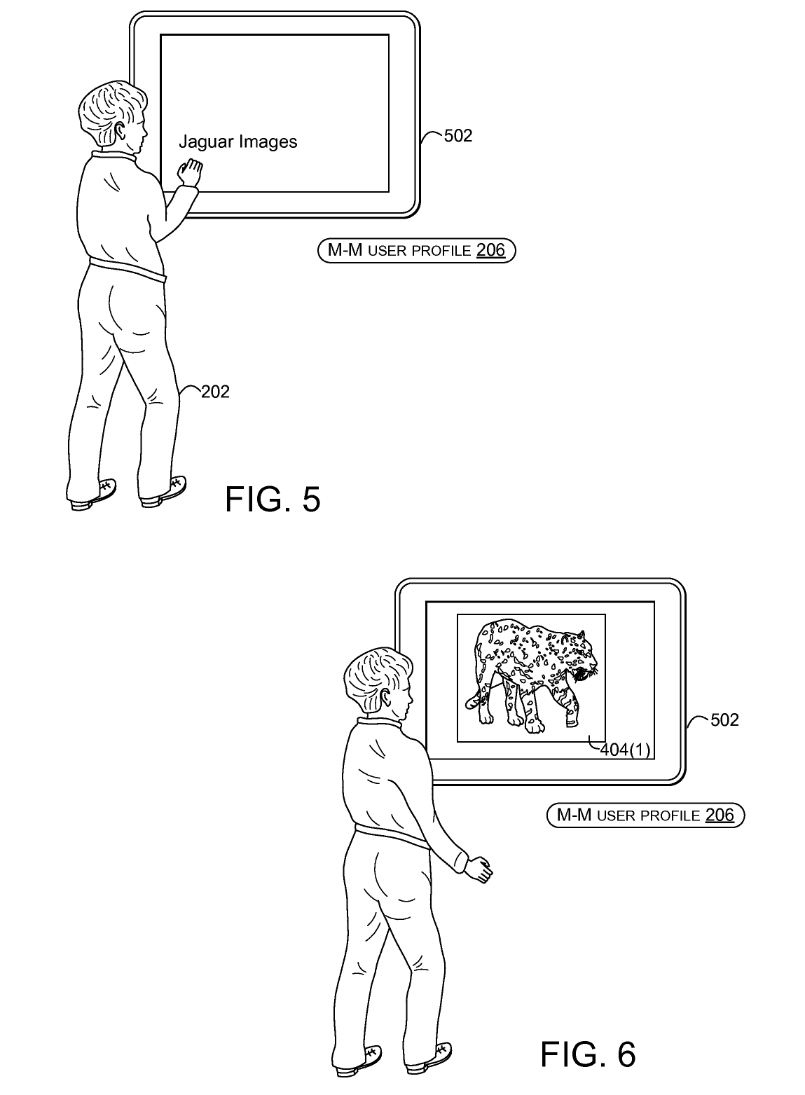

FIG. 5 shows a subsequent instance where the user 202 again queries for “jaguar images” on another device 502. FIG. 6 shows results obtained by using the user's memory-mimicking user profile 206. In this case, the image 404(1) that is displayed for the user is the left image that the user dwelled on in FIG. 4. In this example, the user's visualization information in the memory-mimicking user profile 206 relative to FIG. 4 indicates that the user has already viewed the right image 404(2) and was not interested in the image. Thus, a decision was made not to display that image to the user again. Of course, this is only one simplified example of how the visualization information from the memory-mimicking user profile 206 can be leveraged.

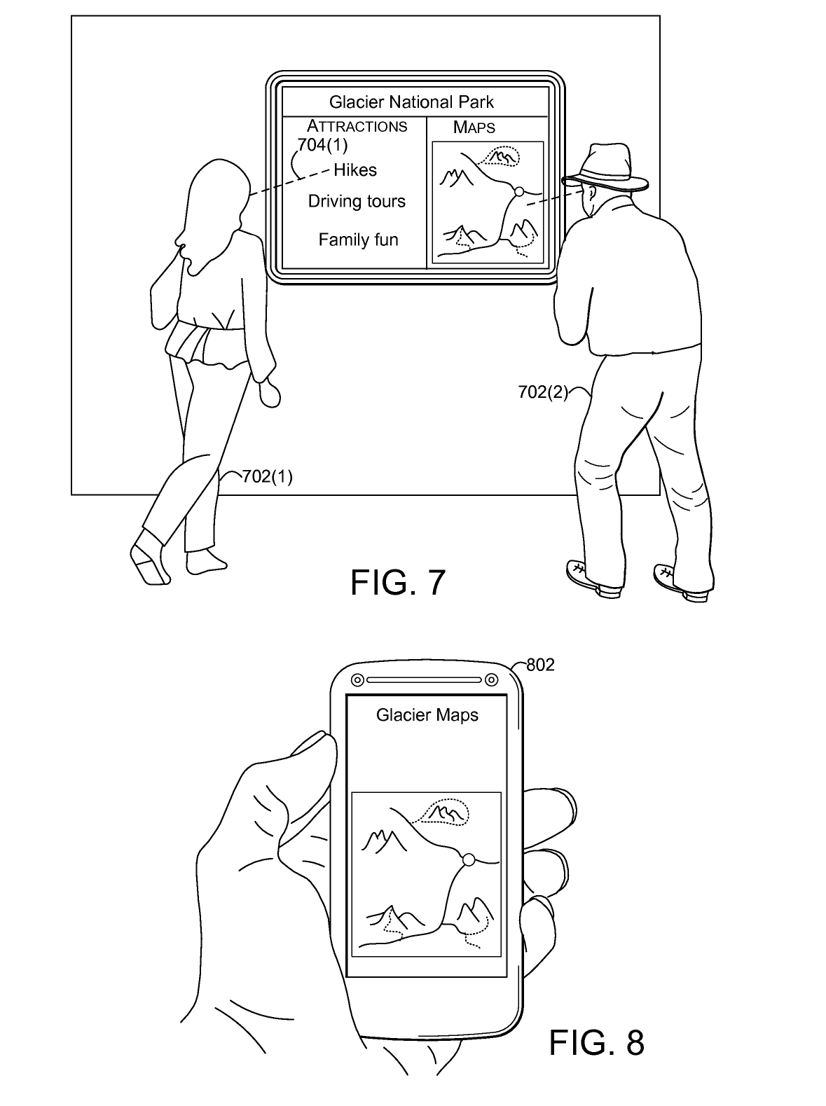

FIGS. 7-8 illustrate another visualization scenario. In FIG. 7, two users 702(1) and 702(2) are viewing an informative display inside a visitor center at Glacier National Park. The users 702(1) and 702(2) can be distinguished from one another using various techniques. Further in this case, assume that each user is identified. (Techniques for identifying and/or distinguishing users are described below relative to FIGS. 11-15). As indicated at 704(1), the user 702(1) on the left is looking at hikes in the park. The user 702(2) on the right is looking at a map of the park (indicated by a dotted line from user to map, but not specifically designated due to space constraints on the drawing page). This visualization information for each user can be added to their respective memory-mimicking user profiles (not shown).

Relative to FIG. 8, assume that the user 702(2) on the right walks back to his car and wants to view on his smart phone 802 the map that he just saw in the visitor center. In this case, the user entered a search query “glacier maps.” Traditional technologies may provide erroneous results to the user, such as “maps of glaciers in Alaska.” Further, even if existing technologies properly identified that the user wanted a map of Glacier National Park, there may be dozens or hundreds of different maps in existence. In contrast, as evidenced in FIG. 8, the present implementations can utilize the user's visualization information from his memory-mimicking user profile to retrieve the exact map that the user viewed in the visitor center. Thus, the present implementations can correctly retrieve the desired user results using the visualization information and thereby provide an enhanced user experience over existing technologies.

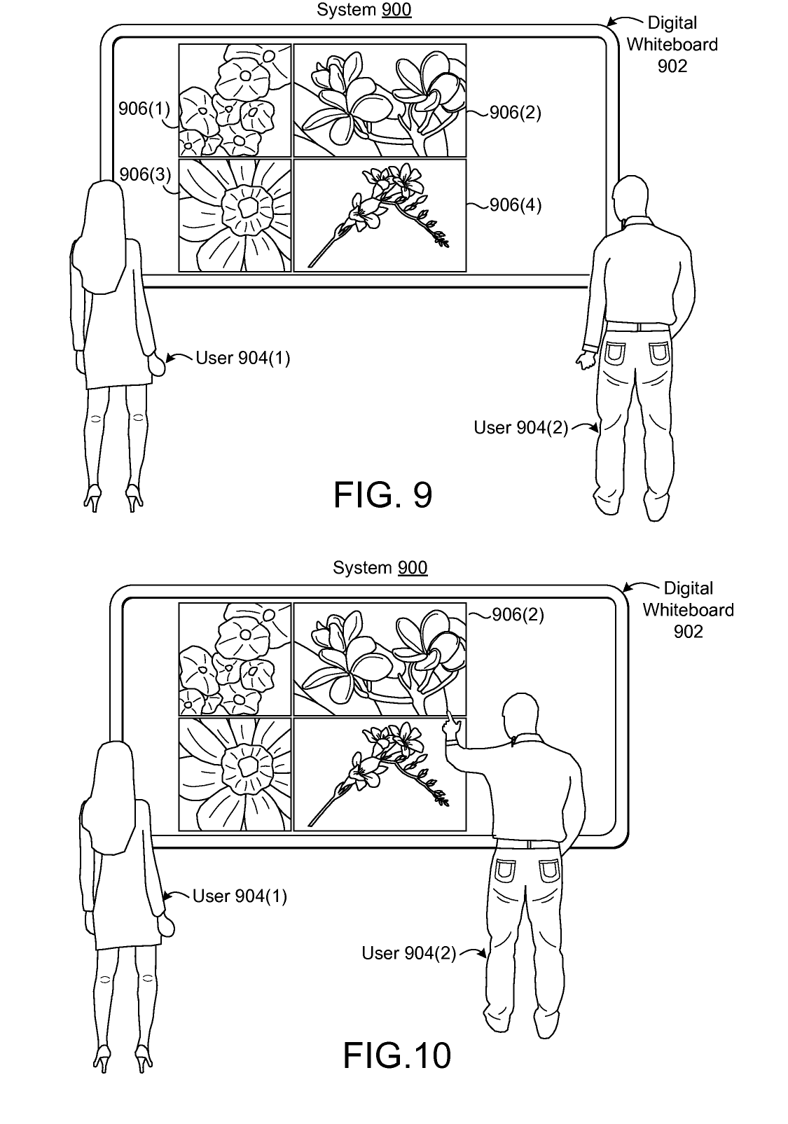

Of course, the illustrated examples tend to be relatively simple examples due to the constraints of the drawing page. However, note that the visualization information can be processed and utilized in various ways. Some of these aspects are described in more detail below relative to the systems and devices of FIGS. 9-15 and/or the methods of FIGS. 16-17.

FIGS. 9-10 collectively illustrate another visualization system 900 involving a digital whiteboard device 902 and two users 904(1) and 904(2). In this example, four images 906(1)-906(4) of flowers are displayed on the digital whiteboard device. Assume that the users are looking at the flower images and discussing them. In this case, the system can detect that the users look at the images. Further, in this case, the system can detect that the users are both looking at a single image 906(2) at the same time. Further, the system can detect that user 904(2) pointed to the image 906(2) (FIG. 10) while the first user (and the second user) was looking at the image 906(2). This visualization information, including the pointing gesture while both are viewing the image, can be added to memory-mimicking user profiles of the respective users. Other types of data can also be added to the memory-mimicking user profiles. For instance, the discussion (e.g., what the users were saying about the images while they looked at them could also be added to the memory-mimicking user profiles. Thus, each user's memory-mimicking user profile could be updated to reflect what he/she saw, when, with who, and the accompanying discussion.

The visualization information could be used in various ways, such as to determine overlapping interests of these two users and to make subsequent suggestions of content and/or activities for the users based upon the overlapping interests. For instance, if the flower images were photographs of paintings, suggestions could be made about museums where the users could see similar paintings, or prints of the paintings could be identified on-line for sale and presented to the users for purchase. If the images were photographs of real plants, locations of arboretums that had this type of plant could be provided to the users.

Alternatively or additionally, some implementations can generate a memory-mimicking user profile which, rather than being dedicated to an individual user, is dedicated to interaction between these two users (e.g., captures the shared visualizations of these users).

Another option is for the viewed content and/or the digital whiteboard to have memory-mimicking user profiles. For instance, the profile for the content could indicate what users looked at the content, how long they looked at the content, their reaction to the content, etc. Similarly, the digital whiteboard could have a profile of what content was displayed, to whom, their reactions, what they did next (e.g., did they look at similar content), etc. Note also, that while the user viewed digital content on a digital whiteboard in this example, similar configurations could be implemented for physical content, such as the informative display at Glacier National Park in FIG. 7 or the zoo in FIG. 2.

FIG. 11 shows a user visualization implementation system 1100 that is self-contained on a single device 1102 associated with the user 202. The device includes a processor 1104, storage/memory 1106, cameras 1108, a content correlation component 1110, the memory-mimicking user profile 206, and/or an application 1112.

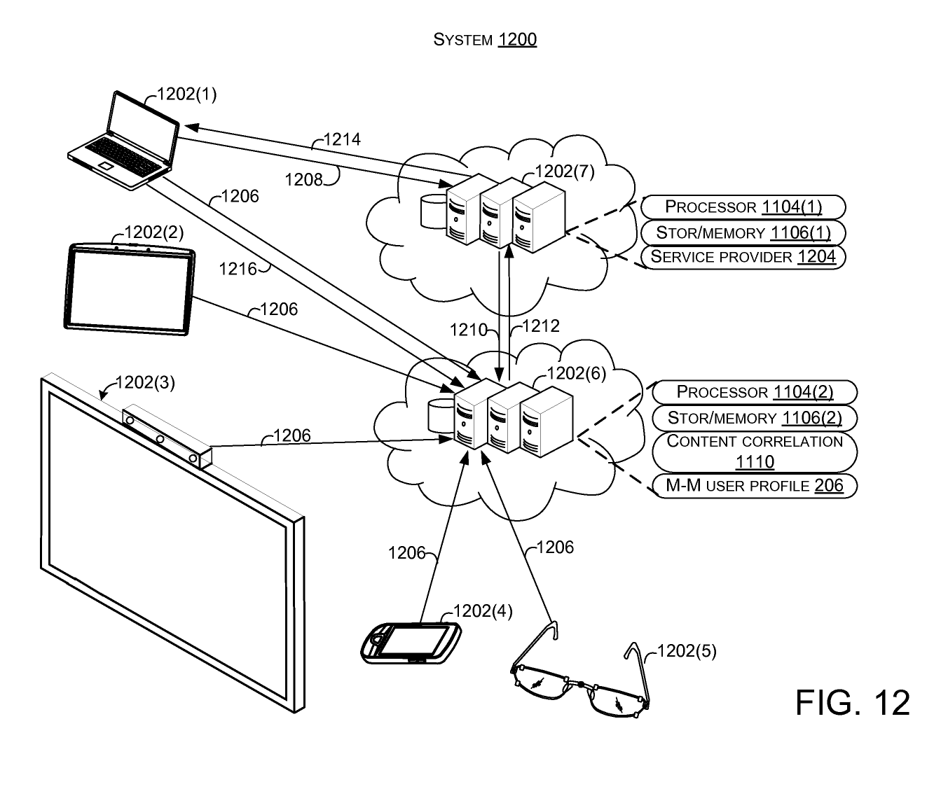

In this example, the user 202 is assumed to be the logged-in user, and as such no further user identification techniques are employed. Alternative scenarios are described below relative to FIGS. 12-15.

In this case, the content correlation component 1110 can track what content on the device the user views. In this example, multiple forward facing cameras 1108(1) and 1108(2) are utilized to track the user's eyes. The content correlation component 1110 can correlate the orientation of the user's eyes to content displayed on a particular location of the device 1102 at the time of the eye tracking. Stated another way, the content correlation component 1110 can map or reference the location the user is looking at to content displayed on that location at that time. Further, the content correlation component 1110 can obtain various additional information about the viewing. For instance, the movements of the user's eyes can be detected by the cameras 1108. The eye movement information can be utilized to determine/confirm that the user was reading content rather than viewing an image, for instance. For example, eye movements tend to be different during reading than viewing. Further, eye movements can change when the user is especially interested in particular content or has difficulty reading a word. For instance, if the user is particularly interested in a passage the user may read the passage multiple times. Also, if a user does not recognize a particular word, the user's eyes may go back over that word multiple times and/or at a different rate than words that the user recognizes.

The content correlation component 1110 can add the visualization information (e.g., viewed content and/or related metadata) to the memory-mimicking user profile 206 on the device 1102. In this case, the content is digital content. As such, the content correlation component 1110 can save the content in the memory-mimicking user profile or reference the content, such as by providing a link to the content that was displayed for the user. The visualization information can also include an indication of a sub-set of the displayed content that was viewed. Stated another way, alternatively or additionally to sending the content to the memory-mimicking user profile 206, the content correlation component 1110 can send a link to a content provider so that the content (displayed and viewed and/or not viewed) can be subsequently accessed and/or retrieved by accessing the memory-mimicking user profile.

Other visualization information can also be added to the memory-mimicking user profile 206, such as time, location, and/or eye movement patterns, among others. The visualization information of the memory-mimicking user profile 206 can be processed in different ways to increase its usefulness. For instance, the visualization information can be indexed, such as by content type, subject matter, time, location, etc. Images of the content can be tagged with metadata to allow indexing.

Subsequently, when services are provided to the user, such as by application 1112, the visualization information of the memory-mimicking user profile 206 can be utilized to enhance the user experience associated with those services.

The device 1102 can alternatively or additionally include other elements, such as input/output devices, buses, graphics cards (e.g., graphics processing units (GPUs)), etc., which are not illustrated or discussed here for the sake of brevity.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the computer. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some configurations, a device can include a system on a chip (SOC) type design. In such a case, functionality provided by the device can be integrated on a single SOC or multiple coupled SOCs. One or more processors can be configured to coordinate with shared resources, such as memory, storage, etc., and/or one or more dedicated resources, such as hardware blocks configured to perform certain specific functionality. Thus, the term “processor” as used herein can also refer to central processing units (CPU), graphical processing units (GPUs), controllers, microcontrollers, processor cores, or other types of processing devices suitable for implementation both in conventional computing architectures as well as SOC designs. Note that individual components, such as the processor, can be implemented in hardware, firmware, software, or any combination thereof.

Examples of devices can include traditional computing devices, such as personal computers, desktop computers, notebook computers, cell phones, smart phones, personal digital assistants, pad type computers, digital whiteboards, cameras, wearable devices, such as smart glasses, or any of a myriad of ever-evolving or yet to be developed types of computing devices.

The user's privacy can be protected by only enabling visualization features upon the user giving their express consent. All privacy and security procedures can be implemented to safeguard the user. For instance, the user may provide an authorization (and/or define the conditions of the authorization) on device 1102. The device only proceeds with eye tracking the user according to the conditions of the authorization. Otherwise, user information is not gathered. Similarly, the user can be allowed to define the use of his/her memory-mimicking user profile that includes visualization data. Any use of the memory-mimicking user profile has to be consistent with the defined user conditions.

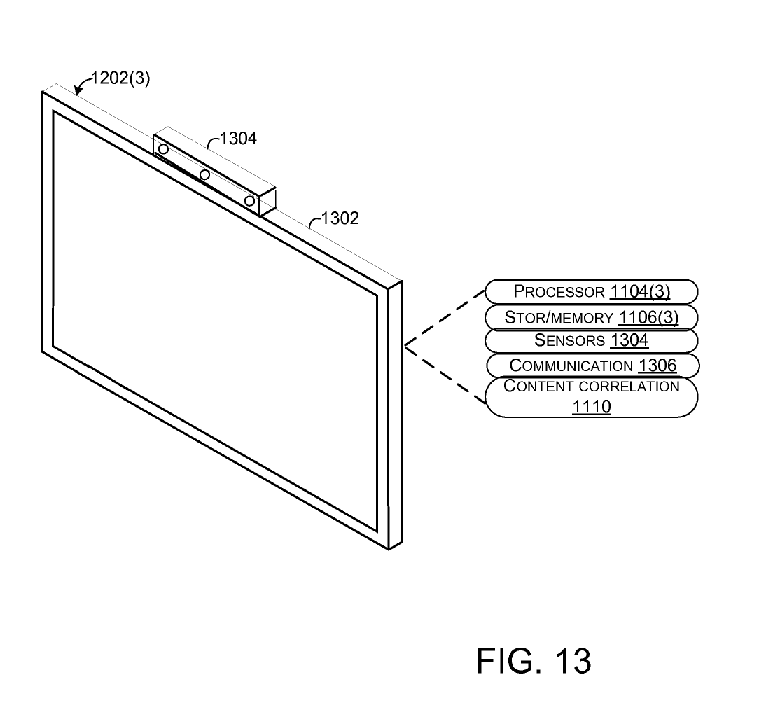

FIG. 12 shows an example distributed visualization system 1200. This system example includes multiple devices 1202(1)-1202(7). In this case, devices 1202(1)-1202(5) can contribute to and/or utilize memory-mimicking user profile 206 that includes user visualization information. In some cases, these devices 1202(1)-1202(5) can be thought of as client-side devices. Some of these devices are described in more detail below relative to FIGS. 13-15. FIG. 11 also describes an example of a device that could function as a client-side device. In that case, the device can maintain a local copy of the memory-mimicking user profile 206 independently of, or in cooperation with, other devices.

For purposes of explanation, in the illustrated configuration devices 1202(6) and 1202(7) are illustrated with processors 1104 and storage/memory 1106. Further, device 1202(6) can include content correlation component 1110 and memory-mimicking user profile 206. (The illustrated components can also occur on the client side devices but are not illustrated due to physical constraints of the drawing page.) Device 1202(7) can include a service provider 1204, such as an application or a search engine, among others.

The client-side devices 1202(1)-1202(5) can gather visualization information. The visualization information can be associated with individual users and sent to device 1202(6) that maintains the memory-mimicking user profile 206 as indicated generally by arrows 1206. While only a single memory-mimicking user profile is illustrated, device 1202(6) could include thousands or even millions of memory-mimicking user profiles for respective users. In some cases device 1202(6) can be a cloud based computing device such as in a server farm. In some configurations, the client-side devices can perform content correlation on the visualization information before sending the visualization information to device 1202(6). For example, the device 1102 of FIG. 11 includes a content correlation component that can accomplish this processing. Alternatively, the processing can be performed on device 1202(6) on visualization information obtained from the individual devices 1202(1)-1202(5). The visualization information can then be stored in the memory-mimicking user profile 206.

Subsequently, an individual user (or group of users) may request a service, such as a web search via an individual device, such as device 1202(1). As indicated by arrow 1208 device 1202(1) may communicate with another device, such as device 1202(7) that provides the service. Device 1202(7) may communicate with device 1202(6) to obtain the user's memory-mimicking user profile 206 as indicated by arrow 1210. Device 1202(6) can communicate the user's memory-mimicking user profile 206 as indicated by arrow 1212. The device 1202(7) can then perform the service using the user's memory-mimicking user profile and provide the results back to computing device 1202(1) as indicated by arrow 1214.

The device 1202(1) can track additional user visualizations associated with the provided service. As indicated by arrow 1216, device 1202(1) can supply this additional user visualization information to device 1202(6) so that the user's memory-mimicking user profile 206 can be updated accordingly. Thus, a user entering a web search query can get web search results based not only upon the query terms, but also upon what the user has previously looked at. In summary, FIG. 12 can be characterized as illustrating a distributed visualization system that can maintain a global memory-mimicking user profile that can include visualization data from multiple devices. The global memory-mimicking user profile can be available to multiple devices to enhance functionality offered to the user.

FIG. 13 shows device 1202(3) in the form of a display device, such as a digital whiteboard, introduced relative to FIG. 12. This device can include a display 1302 and a set of sensors 1304. The set of sensors 1304 can be integral to the display 1302 and/or external to the display. For instance, some of the sensors could be cameras proximate to the display that face outward toward users. Other sensors could be placed remotely from the display and face toward the display to detect user gestures proximate to the display and/or content presented on the display. Some of the cameras can have wide angle lenses to detect users while other cameras can have narrower fields of view to track user eye movements.

The sensors 1304 can include visible light cameras, non-visible light cameras, biometric sensors, RFID sensors, one or more IR sensor/emitter pairs, and/or various communication components for detecting other devices, among others. For instance, a communication component 1306 can allow the device 1202(3) to detect personal devices, such as smart phones, smart watches, smart glasses, ID badges, etc. that may be carried by, or associated with users. These devices may have information about the user(s), such as log-in information that can be utilized to identify the user(s). The information from the devices and/or from the biometric sensors can be utilized to identify the user. In some implementations, the identity of each user can be assigned a confidence score. Stated another way, the system can assign a confidence score that it has correctly identified an individual user.

Any combination of sensors 1304 can be utilized to determine which user looked at what content on the display. This visualization information can be sent to another device (such as device 1202(6) of FIG. 12) that maintains memory-mimicking user profiles with the visualization information. The visualization information can be sent in a raw or processed form. For instance, content correlation component 1110 can identify the user and what location on the display 1302 the user looked at. The content correlation component can identify what content was displayed on the location at the time the user looked at the location. The content correlation component can then cause this visualization information to be stored in the user's memory-mimicking user profile. Alternatively, the content correlation component 1110 may identify what location the user looked at a given time and what was displayed on the display at that time and convey that information to another device for processing.

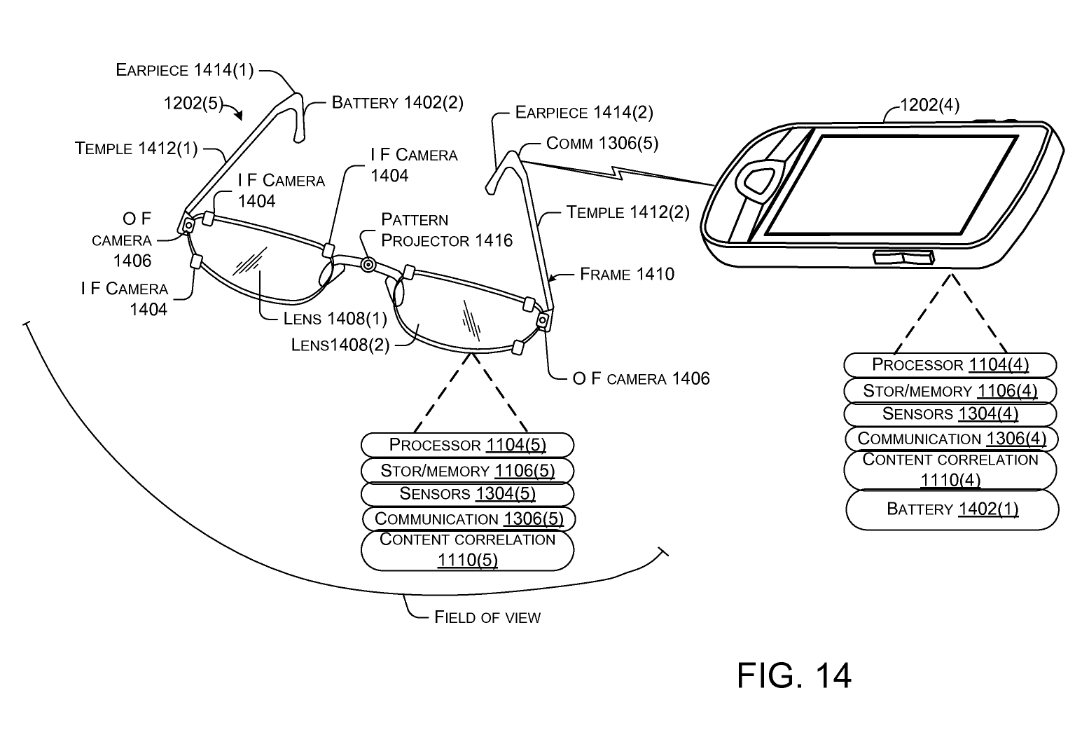

FIG. 14 shows details of devices 1202(4) and 1202(5) introduced in FIG. 12. In this case, devices 1202(4) and 1202(5) can be examples of wearable devices. More particularly, in the illustrated configuration, devices 1202(4) and 1202(5) are manifested as smart phone device 1202(4) and eye-tracking eyeglasses device (e.g., wearable eyeglass device or smart glasses) 1202(5). In this case, the eye-tracking eyeglasses device and the smartphone device can be thought of as personal devices (e.g., belonging to the same user) that can operate cooperatively. Of course, the eye-tracking eyeglasses device could operate more independently. For instance, the eye-tracking eyeglasses device could communicate visualization information to device 1202(6) of FIG. 12 for inclusion in the user's memory-mimicking user profile. However, pairing the eye-tracking eyeglasses device with another local device can decrease resource usage, such as battery usage by the eye-tracking eyeglasses device. Further still, the eye-tracking eyeglasses device could maintain a local memory-mimicking user profile and/or contribute to a global memory-mimicking user profile. In the illustrated configuration, the smart phone device can aid the eye-tracking eyeglasses device to contribute to the global memory-mimicking user profile discussed relative to FIG. 12.

In this case, the smart phone device 1202(4) and the eye-tracking eyeglasses device 1202(5) include instances of processors 1104, storage/memory 1106, sensors 1304, communication components 1306, content correlation components 1110, and/or batteries 1402. The eye-tracking eyeglasses device 1202(5) can also include cameras 1404 and 1406, lenses 1408(1) and 1408(2) (corrective or non-corrective, clear or tinted) and/or frame 1410. The frame can include a pair of temples 1412(1) and 1412(2) terminating in earpieces 1414(1) and 1414(2).

The eye-tracking eyeglasses device 1202(5) can include two basic features. First, the eye-tracking eyeglasses device can include the ability to track the user's eyes. Second, the eye-tracking eyeglasses device can include the ability to simultaneously view the environment in the direction the user's eyes are looking. These features can be accomplished by sensors 1304(5). In this implementation, the first functionality is accomplished with a set of sensors that track the user's eyes. Similarly, the second functionality is accomplished with another set of sensors that simultaneously detect the content at the location that the user is looking. In this example, the first set of sensors includes multiple inwardly facing cameras 1404 per eye. These cameras 1404 point in at the user's eyes. The data that the inwardly facing cameras provide can collectively indicate the direction that the eyes are pointing. The second set of sensors can be manifest as a second set of cameras. This example includes two outwardly facing cameras 1406 that can capture images of the content at a location intercepted by the direction the eyes are pointing.

While distinct sensors in the form of cameras 1404 and 1406 are illustrated, it is envisioned that the sensors may be integrated into the eyeglasses, such as into lenses 1408(1) and 1408(2) and/or frame 1410. In a further implementation, a single camera could receive images through two different camera lenses to a common image sensor, such as a charge-coupled device (CCD). For instance, the camera could be set up to operate at 60 Hertz (or other value). On odd cycles the camera can receive an image of the user's eye and on even cycles the camera can receive an image of what is front of the user (e.g., the direction the user is looking). This configuration could accomplish the described functionality with fewer cameras.

In this case, the outward facing cameras 1406 can be aided by a non-visible light pattern projector 1416. The non-visible light pattern projector can project a pattern or patterned image (e.g., structured light) that can aid in differentiating objects proximate to the location (that the user is looking at). The structured light can be projected in a non-visible portion of the radio frequency (RF) spectrum so that it is detectable by the camera but not by the user. For instance, if the user looks at a jaguar in a zoo exhibit, the pattern can make it easier to distinguish the jaguar from the habitat by analyzing the images captured by the outwardly facing cameras 1406. Alternatively or additionally to structured light techniques, the outwardly facing cameras can implement time-of-flight and/or other techniques to distinguish objects that the user is looking at.

The eye-tracking eye-glasses device 1202(5) can capture visualization information relating to the location. Stated another way, the visualization information can provide images captured by the outwardly facing cameras with an indication of what location(s) on the images the user looked at. The visualization information can be communicated to the smart phone device 1202(4), by the communication component 1306(5) such as via Bluetooth, Wi-Fi, or other technology. For instance, the communication component 1306(5) can be a Bluetooth compliant transmitter that conveys raw or compressed visualization information to the smart phone device 1202(4).

The smart phone device 1202(4) can perform content correlation processing on the visualization information received from the eye-tracking eye-glasses device 1202(5). In some cases, the content correlation component 1110(4) can further attempt to identify the content at the location. For instance, the content correlation component can employ various image analysis techniques.

Image analysis techniques can include optical character recognition (OCR), object recognition (or identification), face recognition, scene recognition, and/or GPS-to-location techniques, among others. Other image analysis techniques can alternatively or additionally be included. Further, multiple instances of an image analysis techniques can be employed. For example, two or more face recognition image analysis techniques could be employed instead of just one.

Briefly, image analysis can process pixel data of the location on the images captured by the outwardly facing cameras 1406, along with other data. The other data can include metadata, and/or data, such as eye movement patterns provided by the inwardly facing cameras 1404. For instance, the other data can indicate how long the user looked at a location. Another example of other data that can be useful is eye movement (e.g., saccades and/or fixations) while the user looked at the location.

Image analysis techniques can be applied to the pixel data in a serial or parallel manner. One configuration can be thought of as a pipeline configuration. In such a configuration, several image analysis techniques can be performed in a manner such that the pixel data and output from one technique serve as input to a second technique to achieve results that the second technique cannot obtain operating on the image alone. Regardless of the configuration employed, any information obtained from the processing of the image of the location can be associated with the image, such as in the form of metadata. For instance, the processing may identify that the user looked at a backpack on a table. The identification of the objects (e.g., backpack and table) could be associated with the image as metadata. The image and metadata could then be added to the user's memory-mimicking user profile. In an alternative configuration, the images may be treated as too resource intensive and only the metadata may be added to the user's memory-mimicking user profile. In summary, the above techniques can identify what the user looked at and/or what the user could have looked at but did not (e.g., was visible but not viewed). This processed visualization data can be communicated to the memory-mimicking user profile. Note that the amount and type of processing of the visualization information that occurs on the eye-tracking eye-glasses device 1202(5) (and/or the smart phone device 1202(4)) can depend on resources of a given implementation. For instance, processing resources, storage resources, power resources, and/or available bandwidth can be considered when determining how and where to process the visualization information.

The smart phone device 1202(4) can receive the visualization information from the eye-tracking eye-glasses device 1202(5). The smart phone device 1202(4) may or may not further process the visualization data. The smart phone device can store the visualization data in a local memory-mimicking user profile and/or communicate the visualization information to another device, such as a device that maintains a global memory-mimicking user profile for the user (for instance device 1202(6) of FIG. 12).

As mentioned above, offloading some of the processing and transmitting to a device in close proximity (in this case the smart phone) can decrease resource usage by the eye-tracking eyeglasses. In other configurations, the eye-tracking eyeglasses device 1202(5) can be more self-contained and can transmit visualization data directly to the memory-mimicking user profile maintaining device. Note further, that while not emphasized above, the eye-tracking eyeglasses-device 1202(5) can be used to identify the user. For instance, the inwardly facing cameras 1404 can obtain biometric information of the eyes that can be utilized to identify the user and/or distinguish users from one another.

Note also, that the smart phone device 1202(4) can have other capabilities that can contribute other information to the eye tracking information and thereby further simplify the eye-tracking eyeglasses device 1202(5). For instance, the smart phone device can have GPS sensors/circuitry for determining its location. The smart phone device can associate the location information (and/or other information) with the visualization data before sending the visualization data to the memory-mimicking user profile maintaining device (see FIG. 12). This can eliminate trying to include GPS circuitry in the space constrained eye-tracking eyeglasses device.

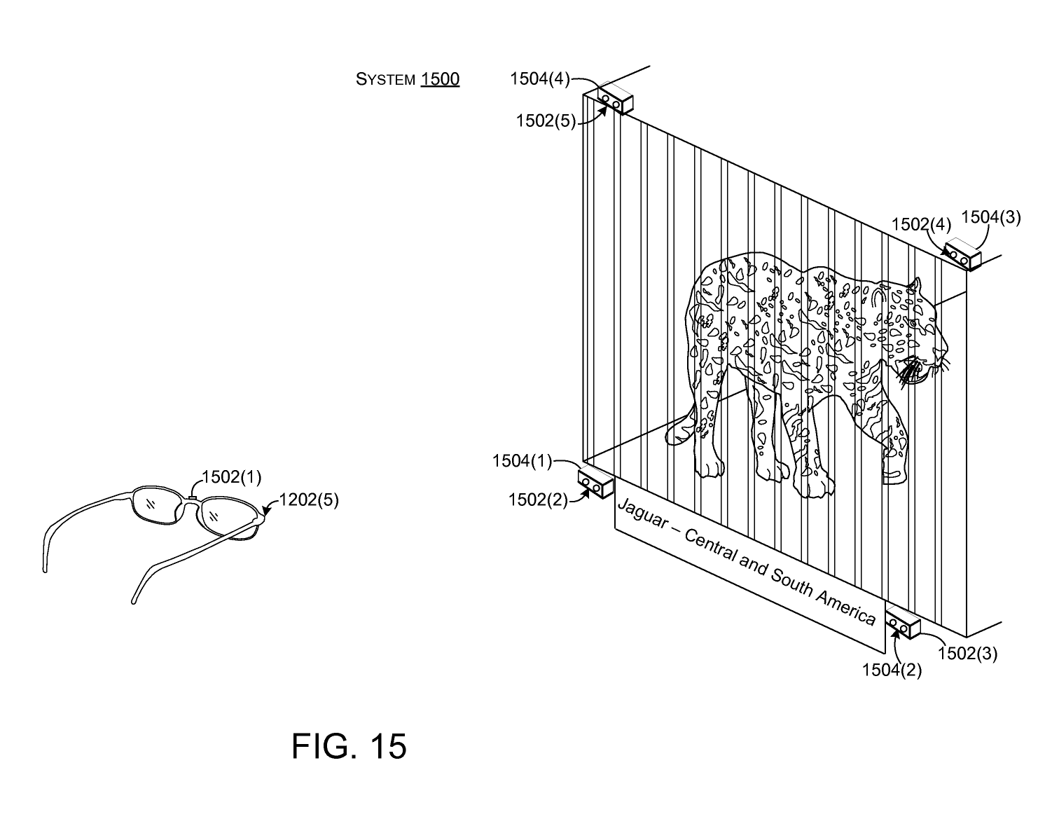

FIG. 15 shows another eye tracking system 1500 configuration described relative to eye-tracking eyeglasses device 1202(5) and the tiger exhibit at the zoo scenario of FIG. 2. In this example, the sensors 1304 (FIG. 13) are manifest as infra-red (IR) sensor/emitter pairs 1502. A first instance of the IR sensor/emitter pairs 1502 is illustrated relative to eye-tracking eyeglasses device 1202(5). Other instances of the IR sensor/emitter pairs 1502 are included on eye-tracking devices 1504. The eye-tracking devices can communicate with one another and/or with a remote device (not shown). Relative to the eye-tracking eyeglasses 1202(5), a single IR sensor/emitter pair 1502(1) is oriented in the same direction as the user looks through the glasses. Relative to the tiger exhibit, the IR sensor/emitter pairs 1502(2)-1502(5) are arranged relative to the exhibit in an outward facing manner (e.g., toward the visitors).

Individual eye-tracking devices 1504 can include at least one IR sensor/emitter pair 1502. The eye-tracking devices 1504 can also have instances of the processor, storage, communication, and content correlation components that are introduced above relative to FIGS. 11-14 and are not reintroduced here for sake of brevity.

The IR sensor/emitter pair 1502 can be configured to detect user eye contact by bright eye/dark eye effect. Thus, the eye-tracking devices 1504 can detect that a user(s) looked at the tiger exhibit. Similarly, the eye-tracking eyeglasses 1202(5) can sense the IR emission from the tiger exhibit and that the IR sensor/emitter pair on the tiger exhibit had detected eye contact. These corresponding signals then enable the inference that this particular user made eye contact with a particular sensor/emitter pair in the environment. Thus the system 1500 can determine and record that the user looked at the tiger exhibit generally (and/or at specific portions) via the collective input provided by eye-tracking devices 1504(1)-1504(4).

As another example, if the user looked at another user who was also wearing eye-tracking eyeglasses 1202(5), then the system could also detect mutual eye contact between the users. This then enables the memory-mimicking user profile to include other persons that the user has met without need for face-recognition or other such potentially resource intensive recognition technologies.

Note further that the above description includes several examples for accomplishing the present concepts. Not all potential implementations are discussed for the sake of brevity. Further, not all components are discussed relative to each device and it should be recognized that other devices can include combinations of the above mentioned components and/or other components.

### First Method Example

FIG. 16 shows an example visualization method 1600.

In this case, the method can display digital content at block 1602. The digital content can include text, handwriting, symbols, characters, images, or any other type of digital content.

The method can determine that a user is looking at a sub-set of the digital content at block 1604. Device configurations for determining what the user is looking at are described above relative to FIGS. 11-15.

The method can relate the user and the sub-set of the digital content at block 1606. The digital content that the user looked at (and did not look at) as well as related metadata can be utilized for various purposes, such as to create/update a memory-mimicking user profile.

### Second Method Example

FIG. 17 shows an example visualization method 1700.

In this case, the method can receive information relating to content that was viewed by a user as well as other information about different content that was visible to the user but not viewed by the user at block 1702. The content can be physical content, digital content, other content, or a mix thereof.

The method can augment a memory-mimicking user profile of the user with the information and the other information at block 1704. In the event that the user does not have an existing memory-mimicking user profile, the augmentation can include creating the memory-mimicking user profile.

The method can allow the information and the other information of the memory-mimicking user profile to be utilized to customize a response to a user input at block 1706. The user input can be a search query or a command. For instance, the user input could be a command to “please make me reservations at the BBQ restaurant I saw yesterday.” The user may use the search query in a traditional sense, but can get more customized and accurate results. Alternatively, the user can use the search query to ‘jog his/her own memory.’ For instance, the user could ask “when did I see the Mona Lisa” or “who was with me when I saw the Mona Lisa?” The visualization information in the user's memory-mimicking user profile would allow the search engine to identify the correct answer. The search engine could present the metadata, such as the date and the names of the people with the user. The search engine could alternatively or additionally present images of what the user saw at the time (e.g., the view of the Mona Lisa from the exact perspective and conditions viewed by the user). Thus, the memory-mimicking user profile can support the user in previously unavailable ways. For instance, the user can search the memory-mimicking user profile as a way of searching his/her own memory for things he/she has seen in the past.

The described methods can be performed by the systems and/or devices described above relative to FIGS. 11-15, and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a processor of a computing device causes the computing device to perform the method.

### CONCLUSION

In summary, what a user looks at (e.g., user visualizations) can be used to prioritize what is important to that user. The present implementations can know what the user sees, both digital and physical and add that to the user's profile (e.g., a memory-mimicking user profile). In this way, the memory-mimicking user profile can essentially mirror the user's memory. The memory-mimicking user profile can effectively allow re-creation of the user's memory/experiences.

The eye tracking techniques can know what the user looked at, for how long, and/or whether the user was reading rather than just looking. Content that the user dwells on may be weighted differently than things the user skims. The eye tracking techniques can know what sentences of a paragraph the user read and/or what paragraphs of a document the user reads; not just that the user looked at a document. Stated another way, the present implementations can know whether the user read the whole document or just part and if so what part.

The eye tracking techniques can enable a circumstance where the user thinks “I have seen this before, maybe a long time ago, but I can't quite recall it.” The system knows what the user has seen and can help recall it. The system can use this information in the context of a search or if the user says, “Can you remind me what I saw about ‘this topic?’”

The visualization enhanced memory-mimicking user profile can be a computational model that (approximately) matches what is in the user's memory. The computational model can know what the user looked at and what the user read, because the computational model knows (e.g., via the eye-tracking) exactly what the user looked at. It can store this information and re-create it later. The visualization information can be indexed to different things, time, physical location, who the user was with, etc. So the user could later ask, “Show me all the things I saw with Joe.”

The visualization of the memory-mimicking user profile can enable enhanced services, such as search. It can create a model of what the user has seen before. This information can be leveraged in that what the user wants to see now may be what the user saw earlier or alternatively not like what the user saw earlier (e.g., the user wants to see something different). The present concepts can be applied to any type of content, physical or digital, text, and/or images.

Although techniques, methods, devices, systems, etc., pertaining to visualization information are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A wearable eyeglass device, comprising:
a pair of lenses positioned for a user to look through;
at least one sensor configured to track an orientation of at least one of the user's eyes;
at least one different sensor configured to simultaneously identify a field of view of the user; and,
at least one correlation component configured to correlate the orientation of the user's eyes to a location in the field of view.

2. The wearable eyeglass device of claim 1, wherein the pair of lenses comprises a left lens configured to be positioned proximate to a left eye of the user and a right lens configured to be positioned proximate to a right eye of the user, and wherein the at least one sensor comprises at least two cameras directed at the left eye and at least two additional cameras directed at the right eye.

3. The wearable eyeglass device of claim 2, wherein the at least one different sensor comprises at least two additional cameras that are directed in a generally opposite direction from the at least two cameras.

4. The wearable eyeglass device of claim 3, wherein the at least one different sensor further comprises a projector configured to project a structured light pattern in a non-visible portion of the radio frequency spectrum and wherein the at least two additional cameras are configured to detect the structured light pattern.

5. The wearable eyeglass device of claim 4, wherein the at least two additional cameras have the same field of view or wherein a first one of the at least two additional cameras has a relatively narrower field of view and a second one of the at least two cameras has a relatively wider field of view.

6. The wearable eyeglass device of claim 3, wherein the at least two additional cameras are configured to utilize time of flight techniques to obtain information about the location.

7. The wearable eyeglass device of claim 1, further comprising a frame for holding the pair of lenses and wherein the frame includes a pair of temples, individual temples terminating in a respective earpiece, and further comprising a battery or other power source contained in a first individual earpiece and a communication component contained in a second individual earpiece.

8. The wearable eyeglass device of claim 7, wherein the communication component comprises a Bluetooth compliant transmitter or a Wi-Fi compliant transmitter.

9. A wearable eyeglass device, comprising:
a frame configured to position the wearable eyeglass device on the head of a user;
a first set of sensors configured to track an orientation of at least one of the user's eyes;
a second set of sensors configured to simultaneously identify a field of view of the user; and,
a correlation component configured to correlate the orientation of the user's eyes to a location in the field of view and to record content from the location.

10. The wearable eyeglass device of claim 9, wherein the frame further includes a processor, storage, and a power source.

11. The wearable eyeglass device of claim 9, further comprising a pair of lenses supported by the frame.

12. The wearable eyeglass device of claim 11, wherein the pair of lenses is corrective lenses.

13. The wearable eyeglass device of claim 9, wherein the first set of sensors and the second set of sensors are the same sensors or wherein the first set of sensors and the second set of sensors are different sensors.

14. The wearable eyeglass device of claim 9, further comprising a projector configured to project a patterned image that is detectable by the first set of sensors but not by the user.

15. The wearable eyeglass device of claim 14, wherein the correlation component is further configured to utilize the patterned image to distinguish an object at the location.

16. The wearable eyeglass device of claim 15, wherein the correlation component is further configured to identify the object.

17. The wearable eyeglass device of claim 16, wherein the correlation component is further configured to associate the identity of the object as metadata to the recorded content.

18. A wearable device, comprising:
sensors configured to identify a location that a user is looking; and,
a content correlation component configured to identify content at the location.

19. The wearable device of claim 18, wherein the sensors comprise cameras.

20. The wearable device of claim 18, wherein the content correlation component is configured to determine whether the content is physical content or digital content.
